(19) United States
(12) Patent Application Publication
(10) Pub. No.: US 2016/0174751 A1
(43) Pub. Date: Jun. 23, 2016

(54) AUTOMATED INFANT FORMULA PREPARATION DEVICES

(71) Applicant: SUMMER INFANT (USA), INC., Woonsocket, RI (US)

(72) Inventors: MICHAEL T. FUSCO, GREENVILLE, RI (US); DAVID E. MEDEIROS, PLAINVILLE, MA (US)

(21) Appl. No.: 14/579,193

(22) Filed: Dec. 22, 2014

(51) Int. Cl. A47J 31/40

(52) U.S. Cl. CPC A47J 31/404

(57) ABSTRACT

An improved formula dispensing assembly for automated infant dry formula machines is provided. The improved dispensing assembly is positioned within the formula powder container of the machine and has a dispensing wheel comprising a plastic disc mounted on the drive shaft and a plurality of expandable, circumferentially disposed, openings that expand upon rotation of the drive shaft and the dispensing wheel to allow formula powder to exit the assembly by gravity.

### FIELD OF THE INVENTION

The invention relates to improvements in devices that automatically prepare infant formula, i.e., machines that dispense predetermined amount of heated water and infant formula powder into a baby bottle that is then shaken by hand.

### BACKGROUND OF THE INVENTION

Automated infant formula preparation machines are known and several different machines have been and are currently being used and sold. Problems with the machines include accurately dispensing the correct amount of infant formula powder and water, maintaining the water at the proper temperature, and preparation time. There have been numerous attempts to solve these and other problems associated with the machines. Examples include those disclosed in the following patents and patent publications:
U.S. Pat. No. 8,584,901 issued to Dooley on Nov. 19, 2013,
U.S. Pat. No. 8,453,562 issued to Lu on
U.S. Pat. No. 8,360,279 issued to Giles on Jan. 29, 2013,
U.S. Pat. No. 8,261,944 issued to Krause on Sep. 11, 2012,
U.S. Pat. No. 6,951,166 issued to Sickels on Oct. 4, 2005,
U.S. Pat. No. 6,766,106 issued to Roberson on Jul. 20, 2004,
U.S. Pat. No. 6,411,777 issued to Roberson on Jun. 25, 2002,
U.S. Pat. No. 6,118,933 issued to Roberson on Sep. 12, 2000,
U.S. Pat. No. 5,570,816 issued to LaBarbera, Jr. on Nov. 5, 1996
U.S. Patent Publication No. 2013/0200101 in the name of Dooley published Aug. 8, 2013, and
U.S. Patent Publication No. 2008/0110935 in the name of Huber published May 15, 2008.

Despite the forgoing and other attempts, there still remains a need for a device that addresses the problem of formula clumping, in which the dry formula particles bind together and/or stick to the formula dispenser, such that the correct amount of dry formula is not dispensed into the bottle and the mixed formula does not have the correct concentration of formula even though the correct amount of dry formula was intended to be dispensed.

The invention disclosed herein addresses that problem by providing an dry formula dispensing assembly that allows any formula that has been dispensed to exit into the bottle. Dry formula dispensing stops when correct weight is achieved.

### SUMMARY OF THE INVENTION

In an automated apparatus for infant formula preparation in conjunction with a bottle, the apparatus having a motor and drive shaft, a water container for storing water, a water heater for heating water to a predetermined temperature, a water delivery system for delivering a predetermined amount of heated water to the bottle, and a formula container for storing powdered infant formula, disclosed herein is an improved infant powder formula dispensing assembly. The assembly is positioned within the formula powder container of the apparatus and has a dispensing wheel that is composed of a plastic disc mounted on the drive shaft and a plurality of expandable, circumferentially disposed, openings that expand upon rotation of the drive shaft and the dispensing wheel to allow formula powder to exit the assembly by gravity. The disc is formed with a plurality of clefts extending through the disc. Each cleft is positioned between one of the plurality of openings in the disc to allow expansion of the holes in the disc upon rotation of the dispensing wheel. Each of the clefts extend from the circumferential edge of the disc along two adjacent sides of an opening. The openings are formed with a slit through the disc that extends from the opening to the circumferential edge of the dispensing wheel, thereby forming a plurality of movable flanges between the clefts and the openings. Each flange is formed with a knob positioned at the end of the flange and perpendicular to the disc surface. The dispensing assembly additionally includes a dispensing wheel cover removably mountable on the dispensing wheel and formed with a plurality of holes superposed on the plurality of disc openings. A dispensing wheel lock is also provided which is rotatably seated on the wheel cover and formed with a downwardly extending circumferential bottom rim having a protrusion on the side facing the disc edge and an upwardly extending circumferential top rim. A stirring fan is provided that is rotatably seated on the wheel lock. The stirring fan is formed with a plurality of spaced apart, slanting blades that are formed and positioned so as to disperse the formula powder in the formula container into the disc openings upon rotation of the drive shaft.

### BRIEF DESCRIPTION OF THE DRAWINGS

FIG. 1 is a perspective view of the infant formula preparation device of the invention.

FIG. 2 is an expanded view of FIG. 1 showing some of the major parts of the device.

FIGS. 3A-3D are detailed perspective views of the interior parts of the dispenser unit of the device.

FIG. 4 is a perspective view of the wheel lock part of the dispenser unit.

FIG. 5 is a perspective view of the bottom of the dispensing wheel part of the dispenser unit.

FIGS. 6A-6C are top perspective views illustrating how the parts illustrated in FIGS. 3B, 3C and 3D are arranged within the dispenser unit.

FIG. 7 is top plan view of the dispensing wheel and wheel lock.

FIG. 7A is a partial bottom plan view of the dispensing wheel and wheel lock with the dispensing wheel in the closed position.

FIG. 7B is a partial bottom plan view of the dispensing wheel and wheel lock with the dispensing wheel in the open position.

### DETAILED DESCRIPTION

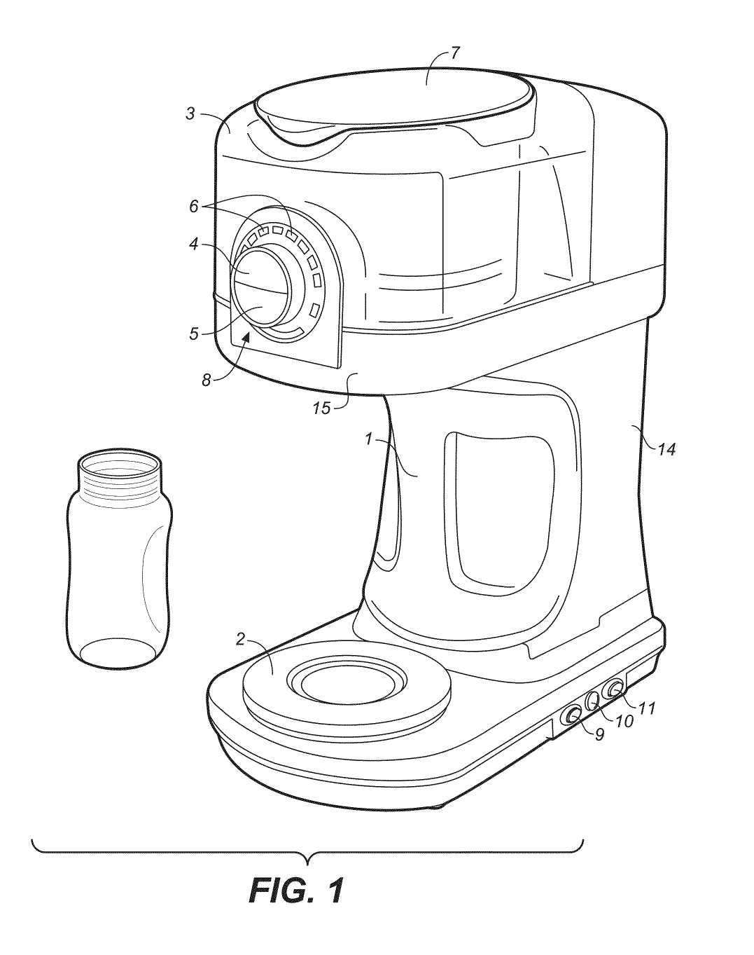

The machine accurately dispenses the correct amount of infant formula powder and water into a baby bottle to make an infant formula mixture. As shown in FIG. 1, the machine is composed of a water tank, 1, a scale, 2, a dispensing unit, 3, a lid, 4, a selection dial, 8, a water temperature switch, 9, a cleaning cycle switch, 10, and a custom formula switch, 11. Water drawn from the water tank 1 is heated as it travels through a water pipe (not shown) past a vertically extending heater which is located within the machine's main housing, 14, behind the water tank (heater not shown). The heated water in the water pipe exits the machine through a water exit hole (not shown) in the bottom of the top portion, 15, of the main housing.

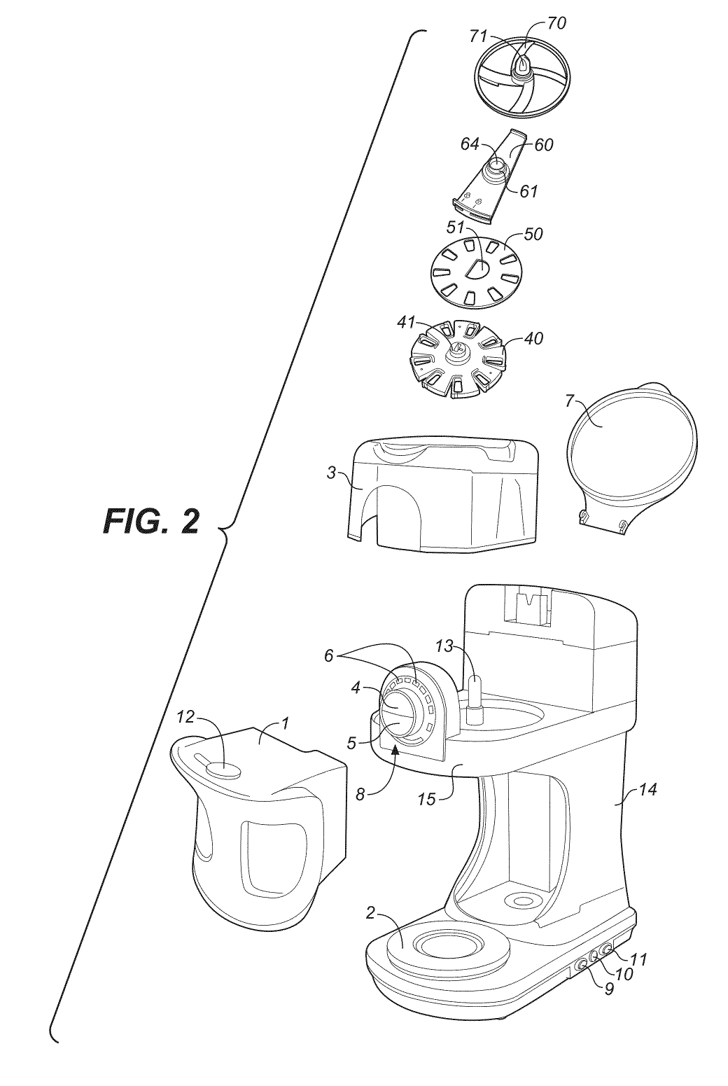

FIG. 2 shows an expanded view of FIG. 1 with the parts of the dispensing unit shown. Water tank 1 is provided with a removable cap, 12, in its top for filling and refilling the tank. The machine is also provided with a motor unit including and connected to a drive shaft, 13, that extends vertically from the body of the machine which houses the motor and into dispensing unit 3. The motor rotates the drive shaft for the period of time controlled by selection dial 8. All of the parts of the motor unit and water dispensing unit need not be shown and described as they are well known in the art, and as described in the various cited patents and patent publications.

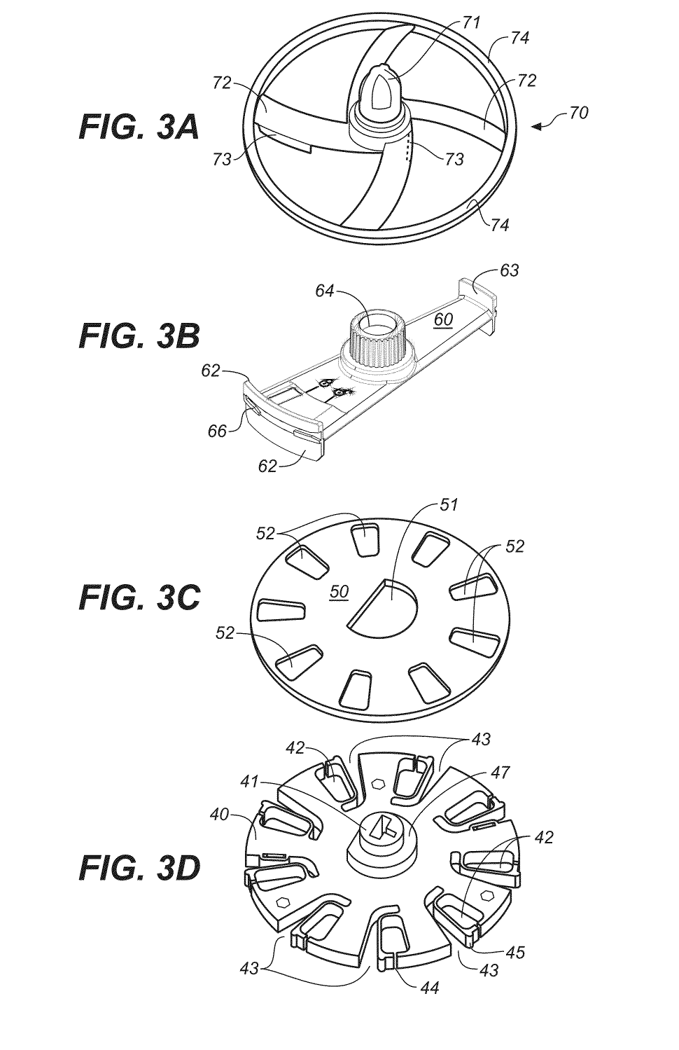

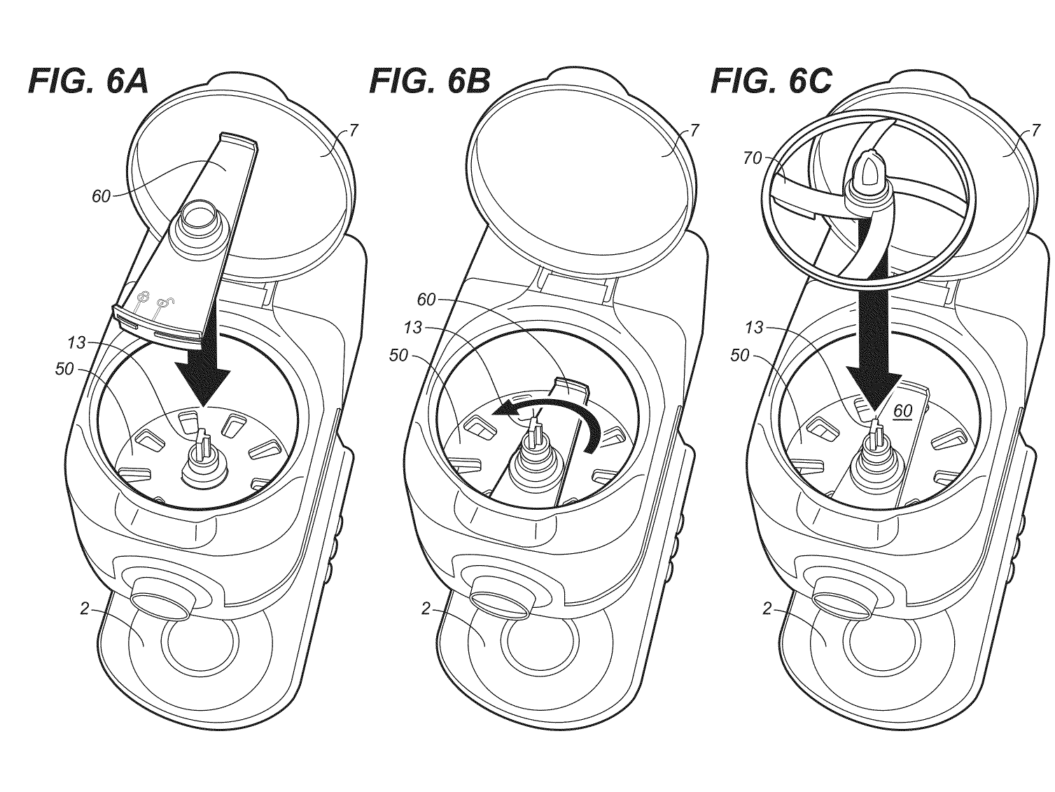

The dispensing unit, 3, contains, from bottom to top, dispensing wheel 40, wheel cover, 50, wheel lock, 60, and stirring fan, 70. Dispensing wheel 40, wheel cover 50 and wheel lock 60 are each formed with a centrally disposed mounting hole for removably mounting the wheel, cover and lock on drive shaft 13. Stirring wheel 70 is formed with a centrally disposed, partially hollow, drive shaft mount 71 that removably orientates it in place on the drive shaft. These parts are shown in greater detail in FIGS. 3A-3D. Within the dispensing unit and removably mounted on drive shaft 13 is dispensing wheel 40, the top of which is shown in FIG. 3D and the bottom of which is shown in FIG. 5. Referring to FIG. 5, dispensing wheel 40 is composed of a circular, planer, plastic disc having a plurality of expandable, circumferentially disposed openings 42 and a plurality of clefts 43. Each cleft, 43, is positioned between one of the plurality of openings 42 and extends from the circumferential edge of the disc along two adjacent sides of an opening. Each opening 42 in the dispensing wheel is formed with a slit, 44, that allows the opening to expand when the wheel rotates as will be explained below. As shown, the openings are generally rectangular is shape, but this is not essential. Other shapes will work, for example square or ovoid. The material and distinctive aspect of the construct is that the opening be formed so as to be expandable when the drive shaft rotates to allow all of the powdered formula, including any clumped formula, to fall through the opening and out of the dispensing unit into the bottle. This is enabled by means of the combination of the juxtaposition of the clefts and the openings and the slits in the openings. The clefts and slits, in effect, create a plurality of spaced apart, circumferentially disposed, retractable flanges (or arms or fingers), 48, in the disc that forms the dispensing unit. At the end of each retractable flange 48 there is formed and positioned a protrusion (or knob or projection), 45. Two flexible wipers, 49, composed of silicon are mounted on a stationary portion of the wheel as illustrated in FIG. 5. As the wheel rotates and the openings 42 expand to allow dry formula to exit the dispensing unit and enter the bottle, wipers 49 push out of the unit any dry formula that might remain in the nozzle (not shown). Centrally disposed on dispensing wheel 40 is dispensing wheel drive shaft mount 41 that enables the dispensing wheel to be removably mounted on the motor drive shaft that extends vertically into the bottom of the dispensing unit. Dispensing wheel drive shaft mount 41 is formed with D-shaped shoulder 47, as can best be seen in FIG. 3D.

Wheel cover 50 is generally planer in configuration and is formed and arranged to be superposable on dispensing wheel 40. The wheel cover has a plurality of spaced apart holes 52, and the holes are disposed and arranged so as to be superposable on the openings, 42, in the dispensing wheel when the wheel cover 50 is placed in position on top of the dispensing wheel. See FIG. 3C. Wheel cover 50 is also formed with centrally disposed, D-shaped aperture, 51, which enables wheel cover 50 to rest on top of the dispensing wheel in a removable, mating engagement with the D-shaped shoulder 47 of the dispensing wheel drive shaft mount 41, thereby allowing the wheel cover and the dispensing wheel to rotate together when the drive shaft rotates. In addition, the engagement of the D-shaped aperture and the D-shaped shoulder assist in maintaining the wheel cover in its proper position on the dispensing wheel. To further assist, the underside of the cover (i.e., the side facing the top surface of the dispensing wheel) may be provided with a plurality of studs (not shown) that engage and sit within a plurality of mating sockets, 46, on the dispensing wheel. See FIG. 5. The purpose or function of wheel cover 50 is to prevent additional dry formula from entering the dispensing wheel clefts 43 when they are in their expanded or open position. This additional dry formula could jam and stop the function of the dispensing wheel.

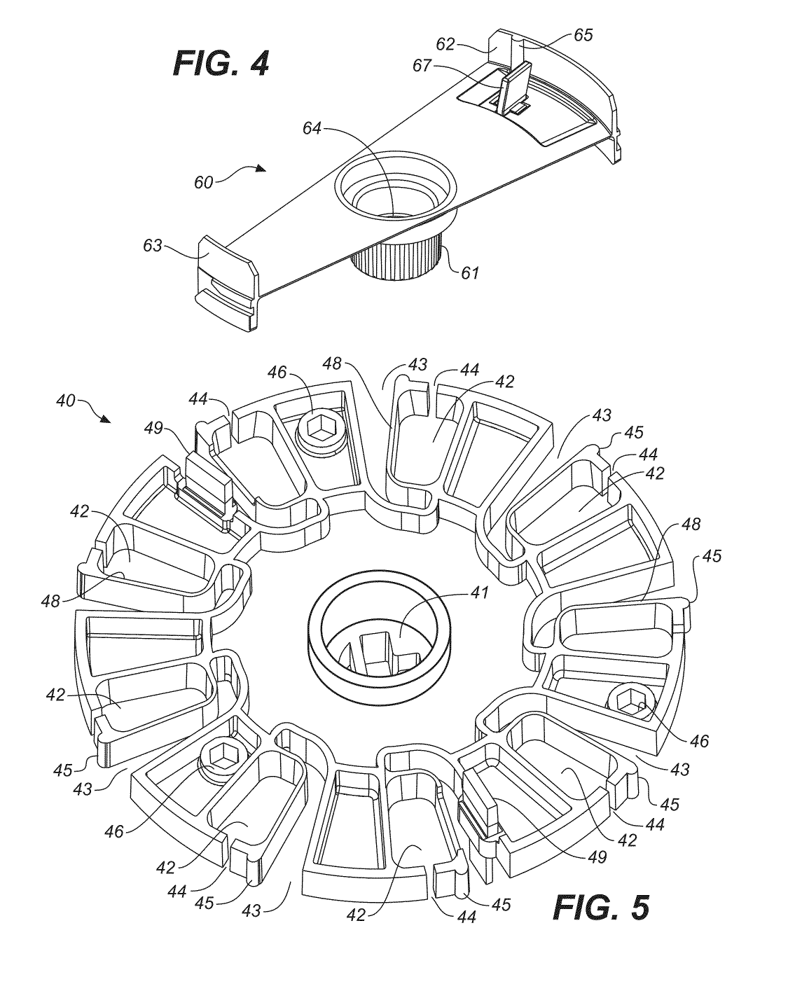

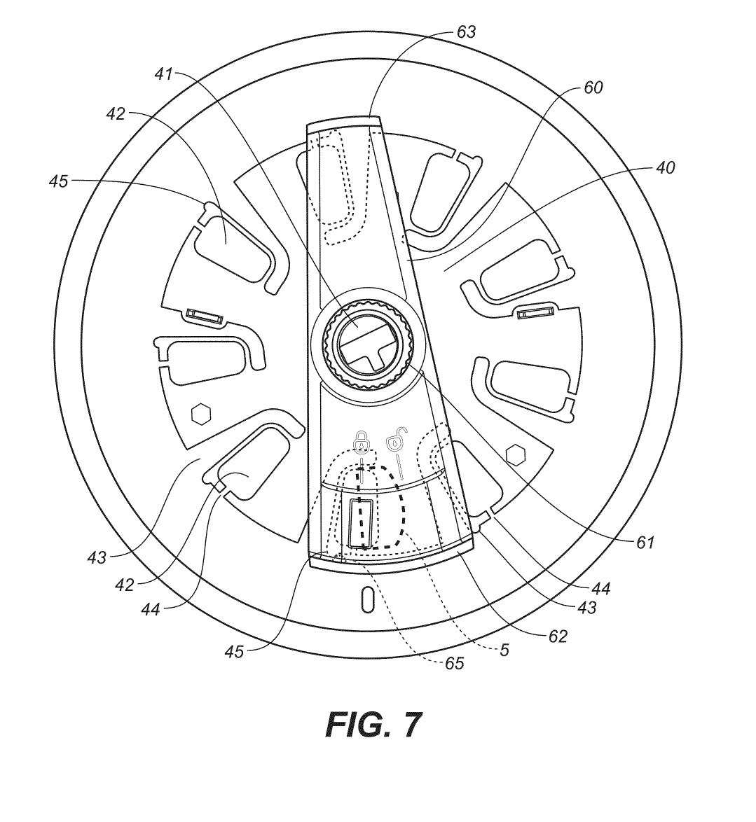

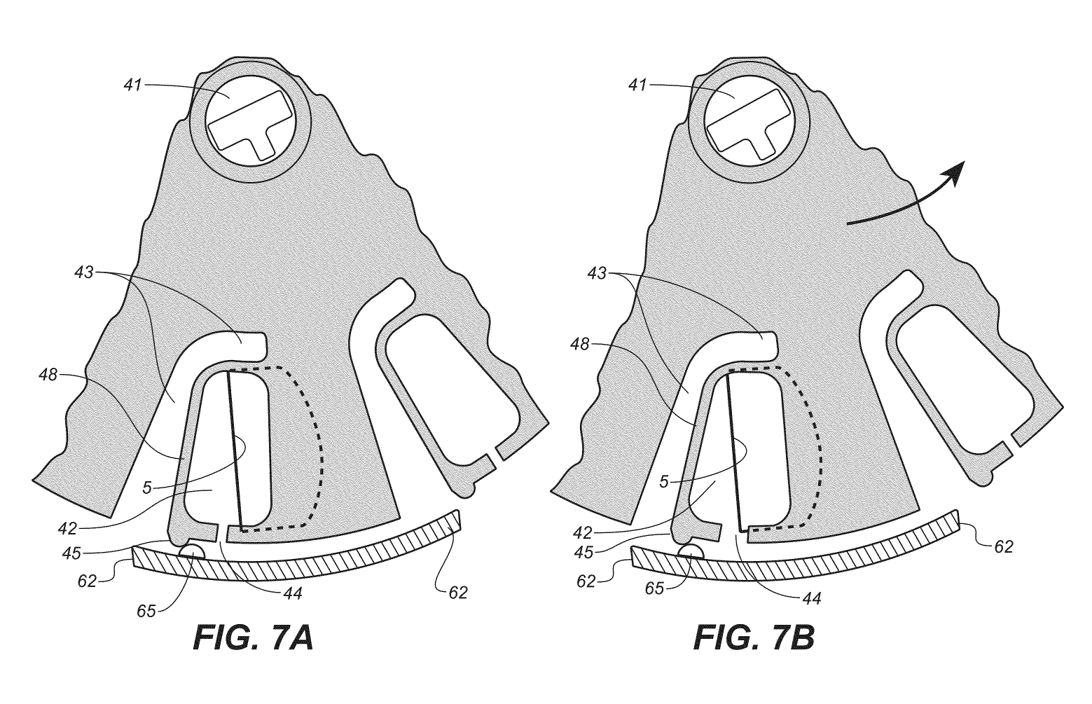

Turning now to FIGS. 3B, 4, and 7, wheel lock 60 is a substantially planer member that is more or less pie shaped, or tapered (alternatively, its longitudinal sides could be parallel). It is formed with centrally disposed wheel lock column, 61, having a bore 64 which enables it to be mounted on the machine's drive shaft. The two circumferential, curved edges of wheel lock 60 are each provided with flanges 62, 63. One edge is formed with one-way flange 63 that extends perpendicularly to the plane of the lock in one direction—upwardly when the lock is positioned in place on top of wheel cover 50 in the dispensing unit. (Alternatively, flange 63 could extend in both directions, upwardly and downwardly perpendicular to the plane of the wheel lock but the downwardly extending flange would serve no purpose.) The opposite edge is formed with two-way flange 62 that extends perpendicularly in both directions. In the upward direction, flanges 63 and 62 function as seats for stirring fan 70. In the downward direction flange 62 extends between the space between the inner surface of the dispensing unit and the circumferential edge of dispensing wheel 40. The interior side of two-way flange 62 (that is the side of the flange that faces column bore 64) is formed with a rib or boss, 65, and the bottom of the wheel lock is provided with an optional additional flexible silicon wiper, 67, to further assist in the complete dispensing of the dry formula and removal of any remaining formula from the openings as the dispensing wheel rotates. As shown rib 65 is disposed closer to one of the sides of the wheel lock on the two-way flange but it could be positioned anywhere along that length of the flange as long as it is positioned to engage protrusion 45 on the dispensing wheel before wiper 67 passes the protrusion as the dispensing wheel rotates. Alternatively rib 65 could be located on the inside surface of the dispensing unit, 3. In this version, the wheel lock is still needed to hold dispensing wheel in place vertically and close off direct access to the formula nozzle (not shown). What is material is that it be formed and arranged so as to slidably engage with protrusion 45 on dispensing wheel. One manner of accomplishing this slidable engagement is as shown in FIG. 7: with both rib 65 and protrusion 45 having sloping sides enabling each to slide past the other as the drive shaft rotates. Other equivalent arrangements are within the level of skill in the art. Referring now to FIG. 3B, flange 62 of wheel lock 60 is also provided with locking slit 66 that enables the wheel lock to be locked into position on top of the wheel cover when it is put in place within the dispensing unit. The interior side of the dispensing unit is formed with a mating lock projection for this purpose (not shown). In operation, wheel lock 60 is placed in the dispensing unit as shown in FIG. 6A and the wheel lock is then rotated counter-clockwise to so that locking slit receives the mating lock projecting in the interior side of the dispensing unit to lock it in position. When the drive shaft rotates, rotating the dispensing wheel and the wheel cover, wheel lock 60 does not rotate. It stays in its locked position. To remove it and the dispensing wheel and wheel cover from the unit, the wheel lock is twisted in the clockwise direction, disengaging the locking slit from the mating lock projection. When the wheel lock is in its locked position and the dispensing wheel and wheel cover rotate the dispensing wheel protrusion meets the wheel lock rib. As the wheel rotates further, the engagement of the protrusion and rib forces the dispensing wheel flexible flange to open, i.e., bend or extend into the cleft. This expands the dispensing wheel opening allowing any remaining dry formula left in the opening to fall through the hopper port in the bottom of the dispensing unit, which is shown in FIGS. 7, 7A and 7B by the D-shaped heavily solid and partially dotted line, 5, and into the bottle. See FIG. 7B. As the wheel rotates further past the boss, the flexible flange snaps back into its original position. See FIG. 7A. As the dispensing wheel rotates, the next dispensing wheel opening reaches the wheel lock rib and forces the flexible flange of that opening to bend or extend into the cleft. FIG. 7 shows a top plan view of the wheel lock and dispensing wheel without the wheel cover in place.

The stirring fan, 70, is a substantially open, circular structure having a rim, 74, and a centrally disposed drive shaft mount, 71, that is formed to removably seat on wheel lock column 61 and engage the drive shaft so as to rotate when the drive shaft, the dispensing wheel and the wheel cover rotate as shown in FIG. 6C. Four angularly disposed and downwardly extending fins, 72, are mounted or connected between the rim and the exterior of the column. Integral with each of the fins and extending downward vertically therefrom is a fin extension 73. Two opposed fin extensions are positioned at the bottommost portion of the fin and adjacent the column. These two fins extensions assist in displacing formula powder as it rotates. The other two opposed fin extensions are positioned at the bottommost portion of the fin adjacent the rim and over the openings 42 in the dispensing wheel and the holes 52 in the wheel cover. These two fins extensions assist in displacing the dry formula into the dispensing wheel openings as the structure the stirring fan rotates. See FIG. 3A.

The formula mixture bottle making operation of this machine is as follows. Formula container is filled with infant formula powder and the water tank is removed, filled with clean water and re-installed into housing. The machine is plugged into a standard outlet. Before turning the unit on the user can, using water temp selection switch 9 on the side of the unit, select to make a baby bottle with water tank temperature water or warm (98.6 degree F. average) water. As noted above, the machine has a default setting of 4.4 grams of formula powder per 1 fl. oz. of water. For this operation description, we will assume that the machine is being run in the default mode. The machine is turned on by pressing the power button, 4. This activates the electronics, the fl. oz. setting lights, the water temperature lights and the water tank lights. The user can now select the size of the formula mixture to be made by turning selection dial 8 to the right or left. Lights on the light ring, 6, will light up to indicate the setting selected. The bottle should now be placed on the scale plate, 2. Pushing the dispense button, 5, will turn on the water heater (if warm water is selected). A temperature sensor (not shown) provides inlet water temperature to electronics. The temperature and formula mixture size selected determines the temperature that the in-line water heater will heat up to, based on pre-programmed software. Once the water heater achieves the correct temperature, the water pump (not shown) turns on and pumps water through the in-line water heater, out the water nozzle and into the bottle on the scale plate. This operation will continue until the electronics sense that 2 fl. oz. of water has been dispensed via the electronic scale signal. At this point, the water pump and water heater are shut off. The electronics now start the motor drive for the formula powder dispensing mechanism. The motor drive rotates the dispensing wheel, 40, at the bottom of the formula container in a counter clockwise direction. Formula powder is dispersed by the stirring fan, 70, which rotates with the dispensing wheel on the same drive shaft. The formula powder falls into the semi-rectangular openings, 42, in the dispensing wheel assembly. The wheel cover, 50, directs the formula powder into dispensing wheel openings 42 and keeps the powder out of other gaps in the dispensing wheel. As the dispensing wheel rotates, it passes under the part of the wheel lock, 60, that is above the formula nozzle. This passing under closes off the top surface of the dispensing wheel and wheel cover, preventing additional formula powder from entering the opening. The inside flange 62 of the wheel lock has a rib, 65, that engages with the matching protrusion, 45, at the end of the flexible flange, 48, on the dispensing wheel. The rotation causes the flange and protrusion to releasably engage and pulls back the flange, widening the wheel opening until it is released. This action occurs as the opening 42 is over the formula nozzle opening. This action causes the formula in opening 42 to be released from the opening, fall into formula nozzle (not shown) and into the baby bottle on the scale. There are nine wheel openings and flanges on the dispensing wheel. Formula falls from each of these openings as the dispensing wheel continues to rotate. Throughout this process, the electronic scale is sending signals for weight of formula powder being added to the baby bottle. Motor rotation is stopped by the electronics when the correct weight of formula powder has been dispensed into the baby bottle. This amount is determined by electronic software calculation. There is also a cam wheel on the drive shaft which opens and closes an electric switch. The electronics monitors the electronic switch opening and closing. This provides feedback as to the location of the cam wheel and the dispensing wheel. The electronics always stop the drive shaft at a location that insures that the dispensing wheel openings are not in alignment with the formula nozzle, to seal the formula container during non-use. If formula mixture being made is over 2 fl. oz., the input water temperature is checked and required water heater temperature is determined by software, and the water heater is turned on. When required water heater temperature is reached, the water pump is turned on and warm water is dispensed into baby bottle. Throughout the water dispensing process, the electronic scale is sending signals for weight of water being added to the baby bottle. Water pump and water heater operation is stopped by the electronics when the correct weight of water has been dispensed into the baby bottle. The electronics signals that the formula mixture is complete by sounding 3 beeps and flashing the status light green until bottle is removed from scale plate. The user can now cap the bottle and gently shake it and check formula mixture temperature before giving to baby. The machine will automatically shut off after 15 minutes of no activity.

The machine will sense and alert the user when it has run out of water or formula powder. For water, the machine senses it is out of water when during the dispensing of water the weight of water does not increase over a 5 seconds period. When this happens, the water pump and heater are shut off; the machine will beep 3 times and the water tank light will flash. The beeping will continue every 15 seconds and the light will continue flashing until water tank is refilled and dispense button is pushed. If water tank is refilled and dispense button is pushed within 5 minutes, the machine will finish making the bottle it has started making before water ran out. After 5 minutes of no activity, it will shut off. It should be noted that repeated pushing of the dispensing button without filling the water tank will cause the machine to shutoff. This is to prevent the water heater from overheating. Every time the dispense button is pushed the water heater will come on followed by the water pump. The water heater and water pump will be shut off after 5 seconds of no weight increase as described above. For formula powder, the machine senses it is out of formula powder during dispensing when the weight of formula powder does not increase over a 10 second period. When this happens the motor is shut off, the machine will beep 3 times and the status light will flash red. The beeping will continue every 15 seconds and the light will continue flashing until formula container is refilled and dispense button is pushed. If formula container is refilled and dispense button is pushed within 5 minutes the machine will finish making the bottle it has started making before formula powder ran out. If refilling does not take place after 5 minutes, the machine will shut off.

The machine can be set to make formula mixtures between 2 fl. oz. to 10 fl. oz. in 1 fl. oz. increments. This is done by turning selection dial 8 to the right to increase the amount of formula added to the bottle and to the left to decrease the amount of formula added to the bottle. The user can also change the amount of formula powder that is dispensed per fl. oz. of water. The machine comes pre-programmed to dispense 4.4 grams of formula for every 1 fl. oz. of water. This is the ratio that many infant formula powder brands specify. For brands that are at different ratios, the machine has a program that allows the user to set a custom amount.

We claim:

1. In an automated apparatus for infant formula preparation in conjunction with a bottle, the apparatus having a motor and drive shaft, a water container for storing water, a water heater for heating water to a predetermined temperature, a water delivery system for delivering a predetermined amount of heated water to the bottle, and a formula container for storing powdered infant formula, the improvement comprising a formula dispensing assembly positioned within the formula powder container and having a dispensing wheel comprising a plastic disc mounted on the drive shaft and a plurality of expandable, circumferentially disposed, openings that expand upon rotation of the drive shaft and the dispensing wheel to allow formula powder to exit the assembly by gravity.

2. The dispensing assembly according to claim 1 wherein the disc is formed with a plurality of clefts extending through the disc, each cleft being positioned between one of the plurality of openings to allow expansion of the hole upon rotation of the dispensing wheel.

3. The dispensing assembly according to claim 2 wherein each cleft extends from the circumferential edge of the disc along two adjacent sides of an opening.

4. The dispensing assembly according to claim 2 wherein the openings are formed a slit through the disc that extends from the opening to the circumferential edge of the dispensing wheel, thereby forming a plurality of movable flanges between the clefts and the openings.

5. The dispensing assembly according to claim 4 wherein each flange is formed with a knob positioned at the end of the flange and perpendicular to the disc surface.

6. The dispensing assembly according to claim 5 additionally comprising a dispensing wheel cover removably mountable on the dispensing wheel and formed with a plurality of holes superposed on the plurality of disc openings.

7. The dispensing assembly according to claim 6 additionally comprising a dispensing wheel lock rotatably seated on the wheel cover and formed with a downwardly extending circumferential bottom rim having a protrusion on the side facing the disc edge and an upwardly extending circumferential top rim.

8. The dispensing assembly according to claim 7 additionally comprising a stirring fan rotatably seated on the wheel lock, the stirring fan having a plurality of spaced apart, slanting blades formed and positioned for dispersing the formula powder in the formula container into the disc openings upon rotation of the drive shaft.
